(19) United States
(12) Patent Application Publication
(10) Pub. No.: US 2002/0166351 A1
(43) Pub. Date: Nov. 14, 2002

(54) Actuating mechanism of a cable lockset

(76) Inventor: Li-Chiue Lee, Taipei City (TW)

Correspondence Address: Li-Chiue Lee, P.O. Box 82-144, Taipei, TW

(21) Appl. No.: 09/850,131

(22) Filed: May 8, 2001

(51) Int. Cl. E05B 67/06

(52) U.S. Cl. 70/49; 70/38 B

(57) ABSTRACT

An actuating mechanism of a cable lockset having a lock body containing a locking-hook hole, a locking-core hole and a horizontal hole, the two ends of the horizontal hole being in communication with the locking-hook hole and the locking-core hole, the locking hook hole allowing a fastening head to be inserted and to be fastened with a steel bead, characterized in that an actuating rod is positioned within the locking-hook hole, and the bottom section of the actuating rod is provided with a spring such that when the fastening head of the cable dislocates from the locking-hook hole, and the pushing of the actuating rod by the spring causes the actuating rod to move upward to be blocked at the lateral side of the steel bead.

### BACKGROUND OF THE INVENTION

(a) Field of the Invention

The present invention relates to an actuating mechanism of a cable lockset, in particular, the lock body of the cable lockset containing a locking core, a rotating disc and a steel bead, by means of the rotation of the rotating disc to move the steel bead, the cable lockset can either be locked or unlocked from a locking position.

(b) Description of the Prior Art

Taiwanese Patent Publication No. 204681, entitled “A Structure Of a Cable Lockset” discloses a lockset comprising a lock housing having a cylindrical tube formed as a unit, a locking-core hole, locking-peg hole and a fastening hole. The front end of the locking peg is provided with a slot such that the two sides of the front end of the locking peg form into a clipping leg to clip the neck portion of the fastening head so as to provide a good fastening force.

Taiwan Patent Publication No. 409763, entitled “Locking Hook of a Padlock” discloses a lockset comprising a lock body having locking core cavity, a first locking-hook recess and a second locking-hook recess, a latch recess at the lateral end of the lock body, a locking-core located within the locking-core cavity, a lock latch slidably mounted within the locking-core cavity, and a U-shaped locking-hook.

The drawbacks of the conventional art are that the single peg lock structure can be easily forced opened by means of an impact force exerted opposite to the pushing force of the spring. The spring will be compressed and the front end of the lock peg is dislocated from the neck portion of the fastening head. Thus, the lock is easily opened.

Accordingly, it is an object of the present invention to provide an actuating mechanism of a cable lockset which mitigates the above drawbacks.

### SUMMARY OF THE INVENTION

Accordingly, it is an object of the present invention to provide an actuating mechanism of a cable lockset having a lock body containing a locking-hook hole, locking-core hole and a horizontal hole, the two ends of the horizontal hole being in communication with the locking-hook hole and the locking-core hole, the locking hook hole allowing a fastening head to be inserted and to be fastened with a steel bead characterized in that an actuating rod is positioned within the locking-hook hole and the bottom section of the actuating rod is provided with a spring such that when the fastening head of the cable dislocates from the locking-hook hole, the pushing of the actuating rod by the spring causes the actuating rod moves upward to be blocked at the side position of the steel bead.

Yet another object of the present invention is to provide an actuating mechanism of a cable lockset, wherein the actuating rod is lifted by means of the spring such that rod is blocked at side of the steel bead and the disc is urged to fasten with the disc shape spring.

Other object and advantages of the present invention will become more apparent from the following description taken in conjunction with the accompanying drawing.

### BRIEF DESCRIPTION OF THE DRAWINGS

FIG. 1 is a perspective exploded view of the present invention.

FIG. 2 is a sectional view of the internal structure of the cable lockset at an open position in accordance with the present invention.

FIG. 3 is a sectional view along line 3-3 of FIG. 2 of the present invention.

FIG. 4 is a sectional view of the internal structure of the cable lockset at a locking position in accordance with the present invention.

FIG. 5 is a sectional view along line 5-5 of FIG. 4 of the present invention.

### DETAILED DESCRIPTION OF THE PRESENT INVENTION

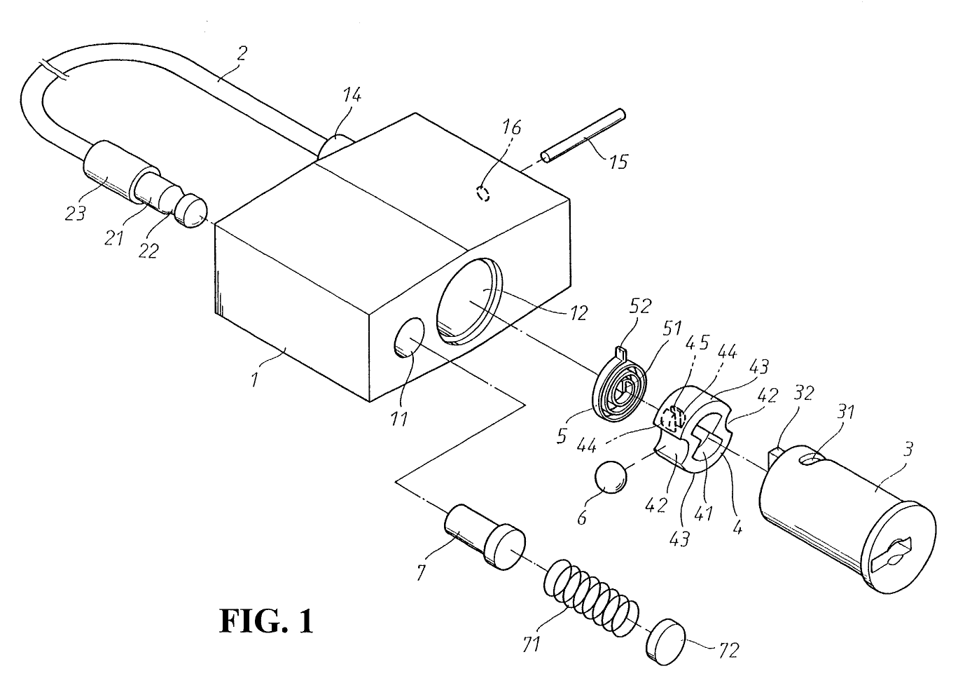

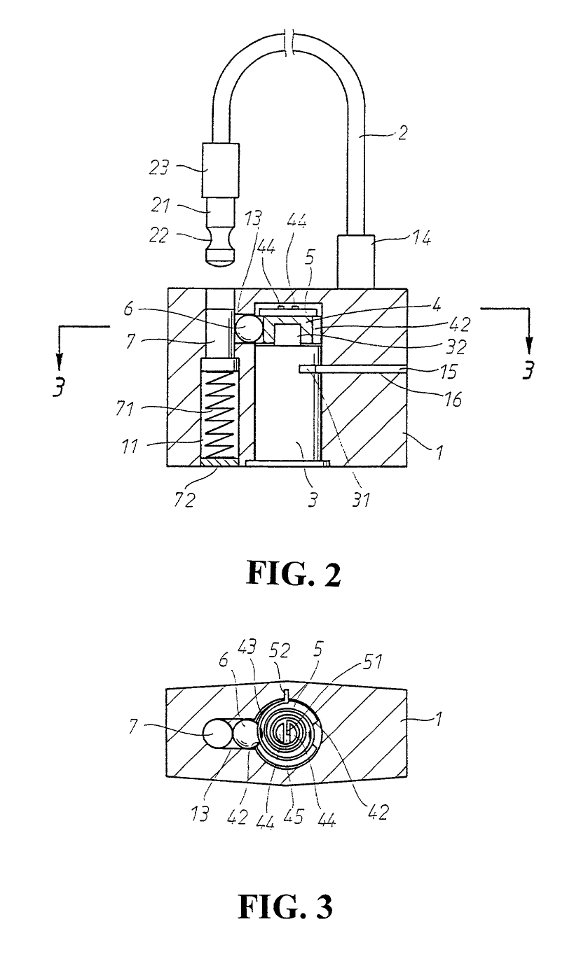

Referring to FIGS. 1 and 2, there is shown an actuating mechanism of a cable lockset comprising a lock body 1 having a locking-hook hole 11, a locking-core body 12 and a horizontal hole 13 therein. The two ends of the horizontal hole 13 are in communication with the locking-hook hole 11 and the locking-core hole 12 in a vertical manner.

The locking-hook hole 11 allows the moving end of a flexible cable 2 to insert therein or withdraw from the hole 11. The moving end is riveted to a fastening head 21 made of a metallic material, and the external diameter of the lower end of the fastening head 21 is provided with a recess 22, or the external diameter of the upper end is mounted with a protective tube 23 made from a plastic material.

The other end of the cable 2 is a fixing end which is riveted to the interior of the cylindrical tube 14. The tube 14 and the lock body 11 is formed as a unit, or the tube 14 is fixed at the interior of the lock body 1, and the tube 14 can also be mounted with a protective tube made of a plastic material.

In addition, the interior of the locking-hook hole 11 is provided with an actuating rod 7 which has a bottom section provided with a spring 71. A seal cover 72 seals the bottom opening of the locking-hook hole 11. Thus, when the fastening head 21 dislocates from the hook hole 11, the lock is at an open position. The actuating rod 7 is pushed by the spring 71 and is moved to be blocked by the side position of the steel bead 6 (as shown in FIG. 2).

The locking-core hole 12 provides combination for the locking-core 3, a rotating disc 4 and a disc-like spring 5. An insertion peg 15 is used and is inserted from the insertion hole 16 to the limiting slot 31 of the locking-core 3. The above-mentioned elements are locked within the interior of the locking-core hole 12. The locking-core 3 is locked within the locking-core hole 12 so that it rotates at a fixed angle.

The top end of the locking-core 3 is provided with a driving key 32 which can be inserted into the hole 41 at the bottom section of the rotating disc 4. The driving key 32 simultaneously rotates the rotating disc 4. By means of the position change of the protrusion 43 or the recess 42, the movement of the steel bead 6 can be controlled.

The top end of the rotating disc 4 is provided with two protruded block 44 forming an engaging slot 45. The slot 45 allows the fixing of the leg 51 of the disc-like spring 5. Another leg 52 of the surrounding of disc-like spring 5 is engaged with the lock body 1.

The function of the spring 5 is that when a key drives the locking-core 3 to the original position, the rotating disc 4 is driven by the spring 5 and returns to the original position.

The horizontal hole 13 allows the insertion of the steel bead 6, and the steel bead 6 is controlled by the protrusion 43 or the recess 42 of the rotating disc 4, which pushes the steel bead 6 to enter in or to retreat out from the hook hole 11 such that the steel bead 6 can urge the fastening head 21 to dislocate from the recess 22 so as to achieve locking or open of the lock.

Referring to FIGS. 2 or 3, there is shown the interior of the lock at the opening of the lock. In accordance with the present invention, a key is inserted into the core 3 so as to drive the core 3 together with the rotating disc 4 to rotate simultaneously.

When the rotating disc 4 rotates, the recess 42 is rotated to align with the steel bead 6 such that the steel bead 6 is positioned at the recess 42 of the rotating disc 4. Thus, the steel bead 6 will not be positioned at the recess 22 of the fastening head 21. Thus the fastening head 21 will be dislocated from the hook hole 11. This is the unlock position of the lock.

At this instance, the actuating rod 7 is subjected to the uplifting of the spring 71 and is blocked at the lateral side of the steel bead 6, forming an engaged state, which in turn, causing the disc-like spring 5 being twisted and having an elastic force (being not in a relaxing state) so as to assure the effectiveness of the locking-core.

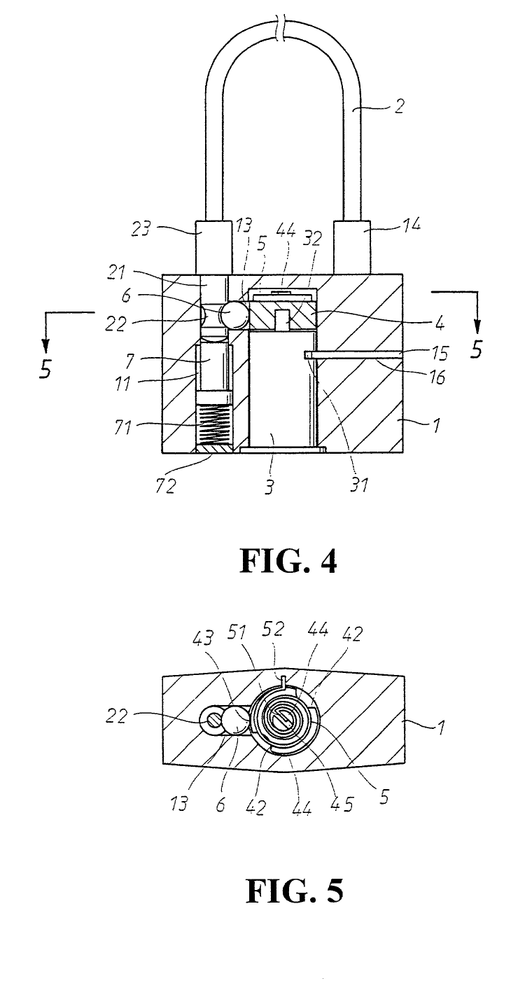

Referring to FIGS. 4 and 5, there is shown the lock in a locking position. When the fastening head 21 of the cable 2 is inserted into the interior of the locking-hook hole 11, the front end of the fastening head 21 can press the actuating rod 7 and the spring 71 to descend so that the recess 22 of the fastening head 21 can align at the position of the steel bead 6.

At this instance, there is no engagement between the rotating disc 4 and the disc-like spring 5. Thus, the rotating disc 4 is driven by the restoration force of the disc-like spring 5 such that the rotating disc 4 rotates to its original position. Then, the protrusion 43 at the surrounding of the rotating disc 4 is corresponding to the steel bead 6 so as to urge the steel bead 6 moves toward the locking-hook hole 11, and in turn, the steel bead 6 is urged to position at the recess 22 of the fastening head 21. Then, the fastening head 21 is locked at the interior of the locking-hook hole 11 by the steel bead 6 and the head 21 will not be dislocated. This is the unlock position of the lock of the present invention.

When an external force impacts the present lock, the steel bead 6 will not be dislocated or moved. Thus, the fastening head 21 and the bead 6 will not be separated as a result of impact.

In view of the above, the combination of the rotating disc 4 and the steel bead 6 will assure that the fastening head 21 will not be dislocated due to external force or impact. Thus, the lock of the present invention provides an anti-burglar function. In accordance with the present invention, the engagement of the bead 6 and rotating disc 4 by means of the actuating rod 7, which causes the disc-like spring 5 being twisted, will assure the effectiveness of the locking-core 3 assembly.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. An actuating mechanism of a cable lockset having a lock body containing a locking-hook hole, a locking-core hole and a horizontal hole, the two ends of the horizontal hole being in communication with the locking-hook hole and the locking-core hole, the locking-hook hole allowing a fastening head to be inserted and to be fastened with a steel bead, characterized in that an actuating rod is positioned within the locking-hook hole and the bottom section of the actuating rod is provided with a spring such that when the fastening head of the cable of the lockset dislocates from the locking-hook hole, the pushing of the actuating rod by the spring causes the actuating rod to move upward so as to be blocked at the lateral side position of the steel bead.

2. An actuating mechanism of a cable lockset as set forth in claim 1, wherein a fixing end of the cable is riveted at the interior of a cylindrical tube, and the cylindrical tube is formed as a unit with a lock body, or the cylindrical tube is fixed to the interior of the lock body.

3. An actuating mechanism of a cable lockset as set forth in claim 1 or 2, wherein the moving end or the fixing end of the cable is mounted with a protective cover.
